(19) United States
(12) Patent Application Publication
(10) Pub. No.: US 2014/0141820 A1
(43) Pub. Date: May 22, 2014

(54) WIRELESS DEVICE AND SWITCHING CONTROL METHOD

(71) Applicant: Fujitsu Mobile Communications Limited, Kawasaki-shi (JP)

(72) Inventor: Naritoshi SAITO, Hino (JP)

(73) Assignee: Fujitsu Mobile Communications Limited, Kawasaki-shi (JP)

(21) Appl. No.: 14/069,014

(22) Filed: Oct. 31, 2013

(30) Foreign Application Priority Data
Nov. 21, 2012 (JP) 2012-255653

(51) Int. Cl. H04W 4/14; H04W 40/24

(52) U.S. Cl. CPC H04W 4/14; H04W 40/246
USPC 455/466

(57) ABSTRACT

A multi wireless system 1 is enabled for communication by CDMA2000 1x of a circuit switching system and by CDMA2000 1xEV-DO and LTE of a packet communication system. The detecting units 54B and 54C detect whether communication by CDMA2000 1xEV-DO and LTE is enabled. The notifying unit 69 notifies an SMS switching control server of which of the circuit switching system and the packet communication system is used to perform SMS communication based on a detection result.

### CROSS-REFERENCE TO RELATED APPLICATIONS

This application is based upon and claims the benefit of priority of the prior Japanese Patent Application No. 2012-255653, filed on Nov. 21, 2012, the entire contents of which are incorporated herein by reference.

### FIELD

The embodiments discussed herein are related to a wireless device and a switching control method.

### BACKGROUND

In recent years, various communication systems, such as CDMA (Code Division Multiple Access) 2000, CDMA2000 1x, and CDMA2000 1xEV-DO (Evolution-Data Only), have been proposed as third generation mobile telecommunications systems (3G: 3rd Generation). CDMA2000 1x is one of technical specifications included in the CDMA2000 standard. In the following, CDMA2000 1x may be simply referred to as “1x”. CDMA2000 1xEV-DO is a standard which is improved from the 1x system and specialized in packet communication to increase communication speed. In the following, CDMA2000 1xEV-DO may be simply referred to as “EVDO”.

In addition, as a wireless communication standard for mobile phones, packet communication systems, such as LTE (Long-Term Evolution) using communication based on an OFDMA (Orthogonal Frequency Division Multiplexing Access) system, have been proposed.

For example, the 1x system and the EVDO system are services that have been widespread in recent years, and therefore, a large number of base stations have been installed and communication areas have been widened. In contrast, the LTE system is a new service relative to the 1x system, is spread mainly in an urban area, and provides a narrow communication area included in the communication area of the 1x system or the EVDO system.

Under such circumstances, in the wireless devices such as mobile phones, for example, a multi wireless device that enables communication using a plurality of communication systems, such as the 1x system, the EVDO system, and the LTE system, has been developed. For example, the multi wireless device uses the 1x system for voice communication and uses the EVDO system or the LTE system for packet communication.

Incidentally, conventional wireless devices such as mobile phones transmit and receive an SMS (Short Message Service) by using only communication by a 1x circuit switching system. In a multi wireless device that can use all of the communication methods of 1X, EVDO, and LTE, it is needed to transmit and receive an SMS by using a packet communication system, such as EVDO or LTE, that enables high-speed communication relative to the 1x circuit switching system.

Patent Literature 1: Japanese Laid-open Patent Publication No. 2008-252335

However, if an SMS is transmitted and received by using a packet communication system, the SMS may come to have difficulty in transmission and reception for a long time according to the state of the communication network. For example, if an SMS is to be transmitted and received from a server by using a packet network while a packet communication network, such as EVDO or LTE, is not available, the SMS may come to have difficulty in reception.

### SUMMARY

According to an aspect of an embodiment, a wireless device that is enabled for communication by a first communication system of a circuit switching system and by a second communication system of a packet communication system with faster communication speed than that of the first communication system, the wireless device includes a detecting unit that detects whether communication by the second communication system is enabled; and a notifying unit that notifies an SMS switching control server on a network of which of the first communication system and the second communication system is used to perform SMS (Short Message Service) communication based on a detection result obtained by the detecting unit.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is an explanatory diagram illustrating an example of a multi wireless system;

FIG. 2 is an explanatory diagram illustrating an example of a relation between a communication area of a 1x/EVDO system and a communication area of an LTE system in a multi wireless system;

FIG. 3 is an explanatory diagram illustrating an example of a multi wireless device;

FIG. 4 is a diagram illustrating a data structure of a pilot signal of an EVDO system;

FIG. 5 is a diagram for explaining a method for detecting whether a device is in the communication area of the EVDO system;

FIG. 6 is a diagram for explaining the method for detecting whether the device is in the communication area of the EVDO system;

FIG. 7 is a diagram illustrating a data structure of a radio frame in an LTE system;

FIG. 8 is a diagram for explaining a method for detecting whether the device is in the LTE communication area;

FIG. 9 is a diagram for explaining the method for detecting whether the device is in the LTE communication area;

FIG. 10 is a diagram illustrating an example of a configuration of a signal generating unit;

FIG. 11 is a diagram illustrating an example of a configuration of a signal generating circuit;

FIG. 12 is a sequence diagram illustrating the flow of operation of an SMS (DAN);

FIG. 13 is a sequence diagram illustrating the flow of operation of IMS Registration;

FIG. 14 is a flowchart illustrating the flow of a switching control process; and

FIG. 15 is an explanatory diagram illustrating a wireless device that executes a switching control program.

### DESCRIPTION OF EMBODIMENT(S)

Preferred embodiments of the present invention will be explained with reference to accompanying drawings. The disclosed technology is not limited to the embodiments below. The embodiments can arbitrarily be combined as long as no contradiction occurs.

### [a] First Embodiment

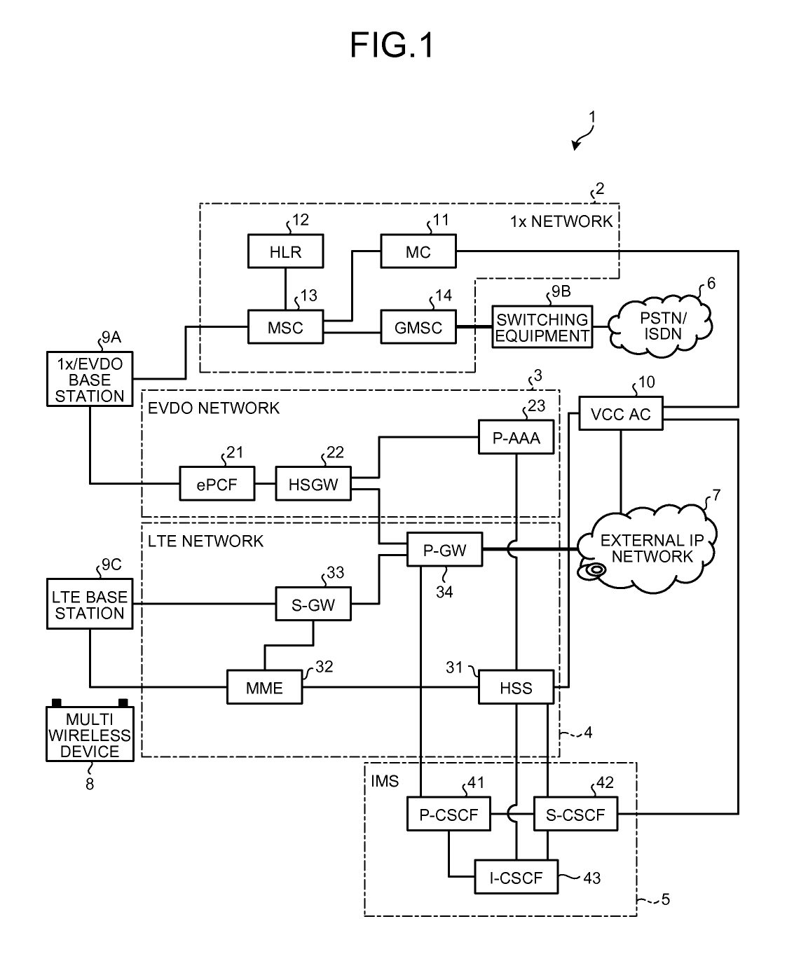

FIG. 1 is an explanatory diagram illustrating an example of a multi wireless system. A multi wireless system 1 includes a 1x network 2, an EVDO network 3, an LTE network 4, and an IMS (IP Multimedia Subsystem) 5. The multi wireless system 1 includes a PSTN (Public Switched Telephone Network)/ISDN (Integrated Services Digital Network) 6, an external IP (Internet Protocol) network 7, and a multi wireless device 8.

The 1x network 2 includes an MC (Message Center) 11, an HLR (Home Location Register) 12, an MSC (Mobile Switching Center) 13, and a GMSC (Gateway Mobile Switching Center) 14. The MC 11 manages messages and distributes the messages for example. The HLR 12 registers and manages subscriber information on service subscribers in the 1x network 2 and location information and authentication information on the service subscribers in an associated manner. The MSC 13 connects to each of 1x/EVDO base stations 9A in a switching manner. The GMSC 14 connects a switching equipment 9B connected to the PSTN/ISDN6 and the MSC 13 in a switching manner.

The EVDO network 3 includes an ePCF (evolved Packet Control Function) 21, an HSGW (High Rate Packet Data Serving Gateway) 22, and a P-AAA (Proxy-Authentication, Authorization and Accounting) 23. The ePCF 21 connects to the 1x/EVDO base station 9A and handles a packet routing function. The HSGW 22 converts data into high-speed packet data of the EVDO system. The P-AAA 23 manages authentication, authorization, and accounting of subscribers in the EVDO network 3.

The LTE network 4 includes an HSS (Home Subscriber Server) 31, an MME (Mobility Management Entity) 32, an S-GW (Serving-Gateway) 33, and a P-GW (Packet Data Network Gateway) 34. The HSS 31 manages information on subscribers in the LTE network 4, or the like. The MME 32 connects an LTE base station 9C and the S-GW 33 and handles sequence control and network control, such as a handover function, location management of a service subscriber, a paging function when the LTE base station 9C receives a call, in the LTE network 4. The S-GW 33 connects to the LTE base station 9C and handles a packet routing function. The P-GW 34 is a gateway that establishes a connection for communication among the HSGW 22 in the EVDO network 3, the external IP network 7, and the S-GW 33. For example, the P-GW 34 enables seamless packet communication between the EVDO network 3 and the LTE network 4. In addition, the HSS 31 and the P-AAA 23 are shared by the EVDO network 3 and the LTE network 4.

The IMS 5 is a system that integrates different communication services, such as a switched telephone network and a mobile communication network, by the IP technology or the SIP (Session Initiation Protocol) to relay data. The IMS 5 includes a P-CSCF (Proxy Call Session Control Function) 41, an S-CSCF (Serving Call Session Control Function) 42, and an I-CSCF (Interrogating Call Session Control Function) 43. The P-CSCF 41, the S-CSCF 42, and the I-CSCF 43 operate on an SIP server (not illustrated). The P-CSCF 41 is accessed by external devices, such as the multi wireless device 8, when communication with different communication services is performed. For example, the multi wireless device 8 accesses the P-CSCF 41 via the P-GW 34 in the EVDO network 3 and the LTE network 4. The S-CSCF 42 is a control unit that controls sessions between different communication services. The I-CSCF 43 is a control unit that functions as a gateway to other communication services.

The multi wireless device 8 is a device of a service subscriber and is compatible with each wireless communication in the multi wireless system 1. A VCCAC 10 is, for example, a server that provides a handover function for voice communication between third generation mobile phones and the external IP network 7. Furthermore, the VCCAC 10 controls an SMS communication path and serves as an SMS switching control server.

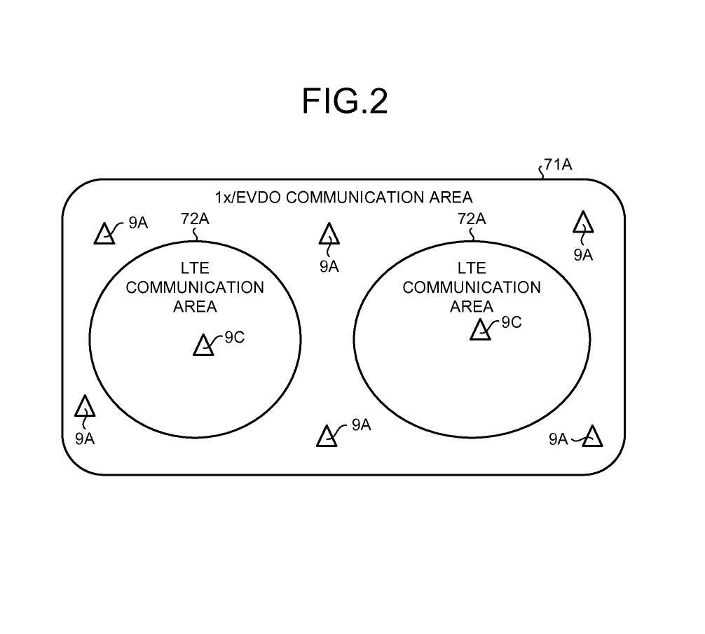

FIG. 2 is an explanatory diagram illustrating an example of a relation between a communication area of the 1x/EVDO system and a communication area of the LTE system in the multi wireless system. The multi wireless system 1 illustrated in FIG. 2 includes, for example, a 1x/EVDO communication area 71A for the 1x/EVDO system and an LTE communication area 72A for the LTE system. The 1x/EVDO communication area 71A is a service that has been widespread in recent years, and the communication area thereof has been widened. In the 1x/EVDO communication area 71A, a voice communication service and a packet communication service are provided. On the other hand, the LTE communication area 72A is a new service relative to 1x/EVDO-based communication, and provides a packet communication service mainly in cities with high-population densities. In the LTE communication area 72A, a high-speed packet communication service is provided. Therefore, the LTE communication area 72A is narrower than the 1x/EVDO communication area 71A. In the 1x/EVDO communication area 71A, a plurality of the 1x/EVDO base stations 9A are installed. In the LTE communication area 72A, a plurality of the LTE base stations 9C are installed.

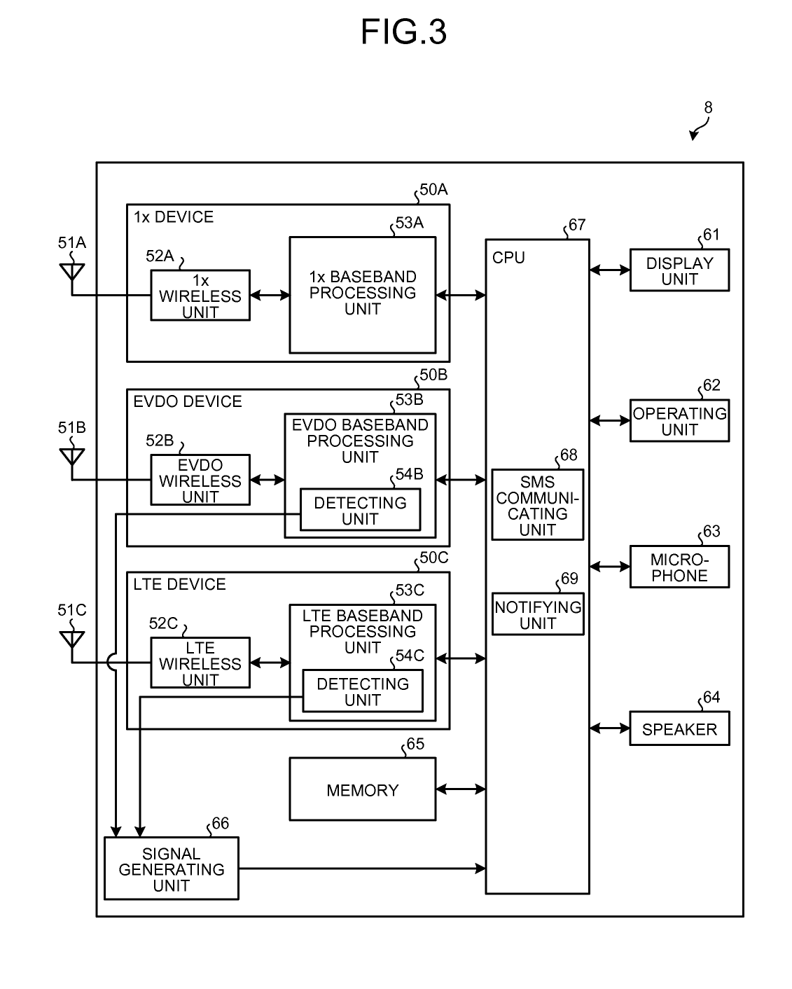

FIG. 3 is an explanatory diagram illustrating an example of the multi wireless device. The multi wireless device 8 illustrated in FIG. 3 includes a 1x device 50A, an EVDO device 50B, and an LTE device 50C. The multi wireless device 8 also includes a display unit 61, an operating unit 62, a microphone 63, a speaker 64, a memory 65, a signal generating unit 66, and a CPU (Central Processing Unit) 67.

The 1x device 50A is an interface that handles wireless communication with the 1x network 2. The 1x device 50A includes an antenna 51A, a 1x wireless unit 52A, and a 1x baseband processing unit 53A. The 1x wireless unit 52A receives wireless signals of various types of data, such as voice and text, that is compliant with the 1x system via the antenna 51A, and converts the frequency of the received wireless signal. The 1x baseband processing unit 53A converts the wireless signal whose frequency has been converted by the 1x wireless unit 52A to a baseband signal, and demodulates the converted baseband signal. In addition, the 1x baseband processing unit 53A modulates transmission data into a baseband signal. The 1x wireless unit 52A converts the frequency of the baseband signal modulated by the 1x baseband processing unit 53A, and outputs the transmission signal with the converted frequency via the antenna 51A.

The EVDO device 50B is an interface that handles wireless communication with the EVDO network 3. The EVDO device 50B includes an antenna 51B, an EVDO wireless unit 52B, and an EVDO baseband processing unit 53B. The EVDO wireless unit 52B receives a wireless signal of various types of data, such as voice and text, that is compliant with the EVDO system via the antenna 51B, and converts the frequency of the received wireless signal. The EVDO baseband processing unit 53B includes a detecting unit 54B. The EVDO baseband processing unit 53B converts the wireless signal whose frequency has been converted by the EVDO wireless unit 52B to a baseband signal, and demodulates the converted baseband signal. In addition, the EVDO baseband processing unit 53B modulates transmission data into a baseband signal. The EVDO wireless unit 52B converts the frequency of the baseband signal modulated by the EVDO baseband processing unit 53B, and outputs the transmission signal with the converted frequency via the antenna 51B.

The detecting unit 54B detects whether communication by the EVDO system is enabled. For example, the detecting unit 54B detects whether the device is in the communication area of the EVDO system based on the wireless signal whose frequency has been converted by the EVDO wireless unit 52B, to thereby detect whether the communication is enabled. The detecting unit 54B outputs a signal indicating a detection result on whether the communication by the EVDO system is enabled to the signal generating unit 66. For example, when the device is in the communication area of the EVDO system and communication by the EVDO system is enabled, the detecting unit 54B outputs a low-level signal to the signal generating unit 66. When the device is outside the communication area of the EVDO system and communication by the EVDO system is not enabled, the detecting unit 54B outputs a high-level signal to the signal generating unit 66.

An example of a method for detecting whether the device is in the communication area of the EVDO system will be explained below. In the EVDO system, data is transmitted after being encoded by a PN (Pseudorandom Noise) code. Each of the 1x/EVDO base stations 9A is assigned with a PN code from among 512 PN codes for base stations, and encodes data by the assigned PN code to transmit the data. Furthermore, each of the 1x/EVDO base stations 9A multiplexes a control signal, such as a pilot signal, and communication data, and transmits the multiplexed data. The pilot signal is a signal with a predetermined bit pattern, and is periodically transmitted in synchronization with the cycle of encoding by a PN code.

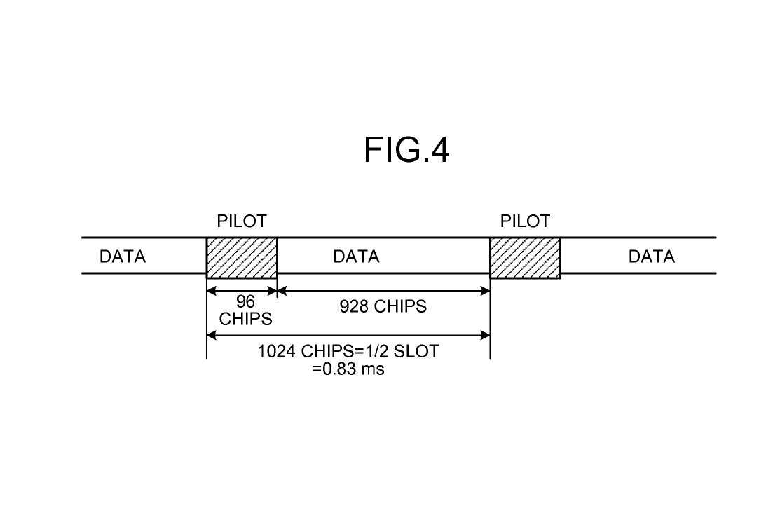

FIG. 4 is a diagram illustrating a data structure of the pilot signal of the EVDO system. As illustrated in FIG. 4, the pilot signal of the EVDO system is in a burst form, and is structured such that 96 chips are inserted in 1024 chips (0.5 Slot). Therefore, the EVDO baseband processing unit 53B performs synchronization in consideration of the fact that the pilot signal is in the burst form.

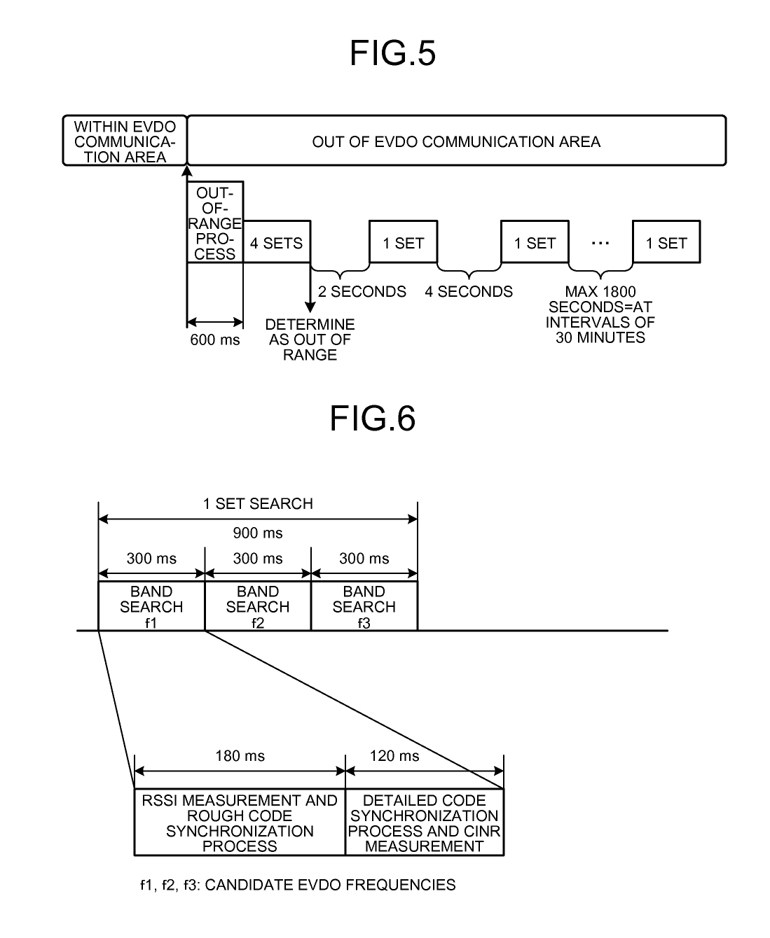

FIG. 5 and FIG. 6 are diagrams for explaining a method for detecting whether the device is in the communication area of the EVDO system. When the multi wireless device 8 moves out of the communication area of the EVDO system, the EVDO baseband processing unit 53B loses synchronization and performs an out-of-range process as illustrated in FIG. 5. The out-of-range process is a period for attempting re-synchronization with the 1x/EVDO base station 9A with which the communication has been performed, and lasts for, for example, 600 ms. When the period of the out-of-range process has elapsed, the EVDO baseband processing unit 53B performs a search process for searching for the 1x/EVDO base station 9A that is enabled to perform communication. In the search process, four sets of Band searches are performed. In the first embodiment, it is assumed that three frequencies f1, f2, and f3 are provided as candidate EVDO frequencies. As illustrated in FIG. 6, a Band search with respect to one frequency includes RSSI (Received Signal Strength Indication) measurement, a rough code synchronization process, a detailed code synchronization process, and CINR (Carrier to Interference and Noise Ratio) measurement. The RSSI measurement and the rough code synchronization process last for, for example, 180 ms. The detailed code synchronization process and the CINR measurement last for, for example, 120 ms. Therefore, the Band search with respect to one frequency lasts for, for example, 300 ms. If no base station is detected at the frequency f1, the same process is performed with respect to the frequencies f2 and f3. One set of searches with respect to the frequencies f1, f2, and f3 takes 900 ms. The four sets of the Band searches means that the searches with respect to the frequencies f1, f2, and f3 are repeated four times. The rough code synchronization process is a process for searching for a PN code to be a candidate for synchronization by sequentially selecting 512 PN codes for base stations and shifting the selected PN code. The detailed code synchronization process is a process for searching for a phase to be synchronized with the PN code detected by the rough code synchronization process. If synchronization with any of the 1x/EVDO base stations 9A is not established by performing the out-of-range process and the four sets of the Band searches, the detecting unit 54B determines that the device is outside the communication area. Once the device moves out of the communication area, the EVDO baseband processing unit 53B repeats one set of the Band search every time a wait time elapses. The wait time is gradually increased to, for example, 2 seconds, 4 seconds, . . . , and up to 1800 seconds every time the device is determined as being outside the communication area.

Referring back to FIG. 3, the LTE device 50C is an interface that handles wireless communication with the LTE network 4. The LTE device 50C includes an antenna 51C, an LTE wireless unit 52C, and an LTE baseband processing unit 53C. The LTE wireless unit 52C receives a wireless signal of various types of data, such as voice and text, that is compliant with the LTE system via the antenna 51C, and converts the frequency of the received wireless signal. The LTE baseband processing unit 53C includes a detecting unit 54C. The LTE baseband processing unit 53C converts the wireless signal whose frequency has been converted by the LTE wireless unit 52C into a baseband signal, and demodulates the converted baseband signal. In addition, the LTE baseband processing unit 53C modulates transmission data into a baseband signal. The LTE wireless unit 52C converts the frequency of the baseband signal modulated by the LTE baseband processing unit 53C, and outputs the transmission signal with the converted frequency via the antenna 51C.

The detecting unit 54C detects whether communication by the LTE system is enabled. For example, the detecting unit 54C detects whether the device is in the communication area of the LTE system based on the wireless signal whose frequency has been converted by the LTE wireless unit 52C, to thereby detect whether communication is enabled. The detecting unit 54C outputs a signal indicating a detection result on whether the communication by the LTE system is enabled to the signal generating unit 66. For example, when the device is in the LTE communication area and communication by the LTE system is enabled, the detecting unit 54C outputs a low-level signal to the signal generating unit 66. When the device is outside the LTE communication area and communication by the LTE system is not enabled, the detecting unit 54C outputs a high-level signal to the signal generating unit 66.

An example of a method for detecting whether the device is in the communication area of the LTE system will be explained below. In the LTE system, time and frequency are multiplexed by using OFDMA to transmit and receive data. For example, in the LTE system, a radio frames is synchronized with each of 12 subcarriers to transmit data.

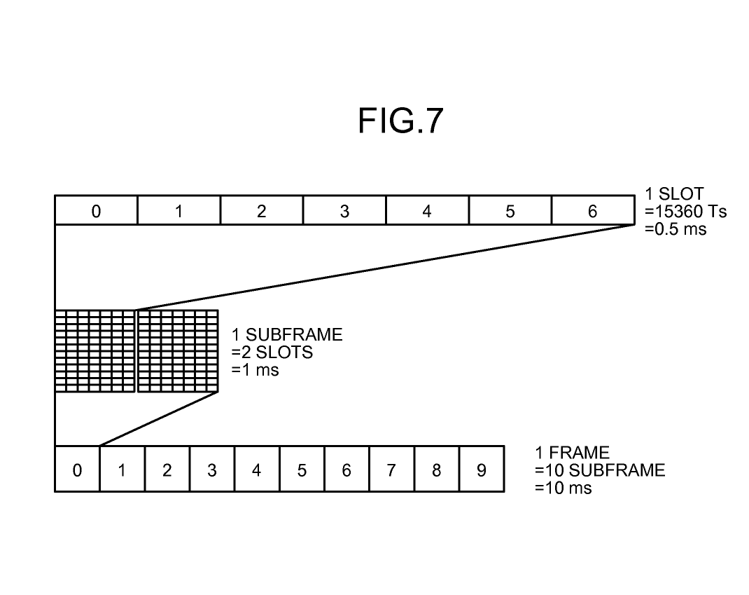

FIG. 7 is a diagram illustrating a data structure of the radio frame of the LTE system. In the radio frame, the length of one frame is set to 10 ms and one frame includes ten subframes each having the length of 1 ms. The subframe includes two slots. One slot includes seven symbols. In the LTE system, transmission data is transmitted by being assigned to and synchronized with a slot of a radio frame of any of subcarriers.

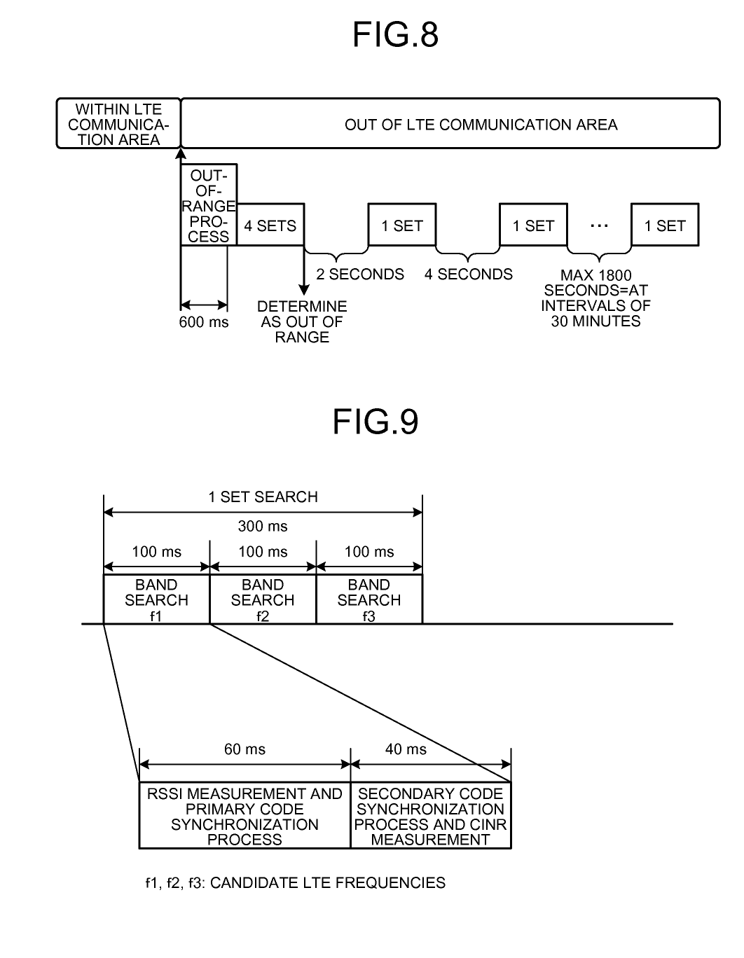

FIG. 8 and FIG. 9 are diagrams for explaining a method for detecting whether the device is in the communication area of the LTE system. When the multi wireless device 8 moves out of the communication area of the LTE system, the LTE baseband processing unit 53C loses synchronization and performs the out-of-range process as illustrated in FIG. 8. The out-of-range process is a period for attempting to re-synchronization with the LTE base station 9C with which the communication has been performed, and lasts for, for example, 600 ms. When the period of the out-of-range process has elapsed, the LTE baseband processing unit 53C performs a search process for searching for the LTE base station 9C that is enabled to perform communication. As illustrated in FIG. 9, four sets of Band searches are performed in the search process. In the first embodiment, it is assumed that three frequencies f1, f2, and f3 are provided as candidate LTE frequencies. A Band search with respect to one frequency includes RSSI measurement, a Primary code synchronization process, a Secondary code synchronization process, and CINR measurement. The RSSI measurement and the Primary code synchronization process last for, for example, 60 ms. The Secondary code synchronization process and the CINR measurement last for, for example, 40 ms. Therefore, the Band search with respect to one frequency lasts for, for example, 100 ms. If no base station is detected at the frequency f1, the same process is performed with respect to the frequencies f2 and f3. One set of searches with respect to the frequencies f1, f2, and f3 takes 300 ms. The four sets of the Band searches means that the searches with respect to the frequencies f1, f2, and f3 are repeated four times. If synchronization with any of the LTE base stations 9C is not established by performing the out-of-range process and the four sets of the Band searches, the detecting unit 54C determines that the devices is outside of the communication area. Once the detecting unit 54C determines that the device is outside the communication area, the detecting unit 54C repeats one set of the Band search every time a wait time elapses. The wait time is gradually increased to, for example, 2 seconds, 4 seconds, . . . , and up to 1800 seconds every time the device is determined as being outside the communication area.

Referring back to FIG. 3, the display unit 61 is an output interface for displaying various types of information on a screen. The operating unit 62 is an input interface for inputting various types of information. The microphone 63 is an input interface for collecting various sounds. The speaker 64 is an output interface for outputting various sounds. The memory 65 is an area for storing various types of information.

The signal generating unit 66 generates various signals based on signals input by the detecting unit 54B and the detecting unit 54C. For example, the signal generating unit 66 generates a first signal indicating whether both of the EVDO system and the LTE system are out of range, based on signals input by the detecting unit 54B and the detecting unit 54C. Furthermore, the signal generating unit 66 generates a second signal indicating a timing at which the state of the first signal changes. The signal generating unit 66 outputs the generated first signal and the generated second signal to the CPU 67.

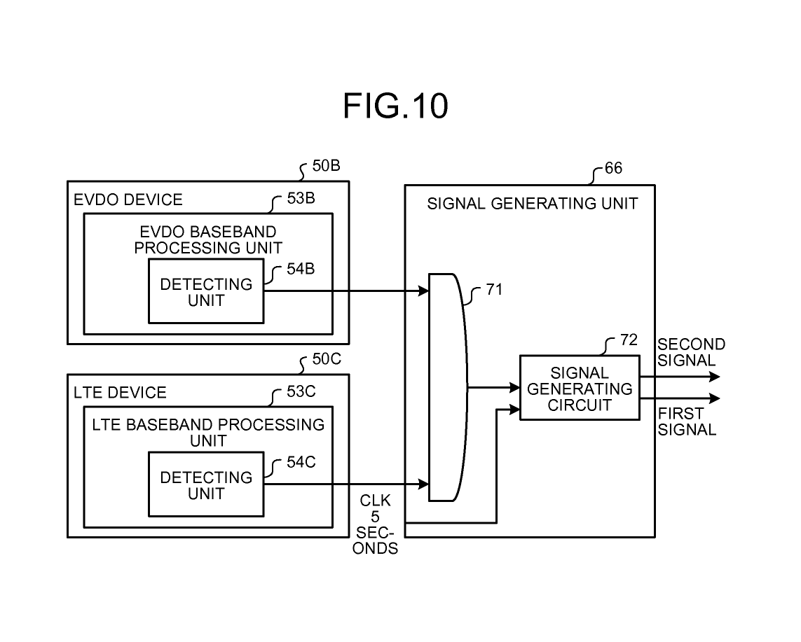

FIG. 10 is a diagram illustrating an example of a configuration of the signal generating unit. The signal generating unit 66 includes an AND circuit 71 and a signal generating circuit 72. The AND circuit 71 receives signals input by the detecting unit 54B and the detecting unit 54C, and outputs an AND result of the two signals to the signal generating circuit 72. For example, when receiving high-level signals indicating that the device is outside the communication areas from both of the detecting unit 54B and the detecting unit 54C, the AND circuit 71 outputs a high-level signal. Furthermore, when receiving a low-level signal indicating that the device is in the communication area from one or both of the detecting unit 54B and the detecting unit 54C, the AND circuit 71 outputs a low-level signal.

The signal generating circuit 72 receives a signal output by the AND circuit 71. A clock signal indicating a timing to judge a signal is input to the AND circuit 71 with a constant period. In the first embodiment, the period of the clock signal is set to, for example, 5 seconds.

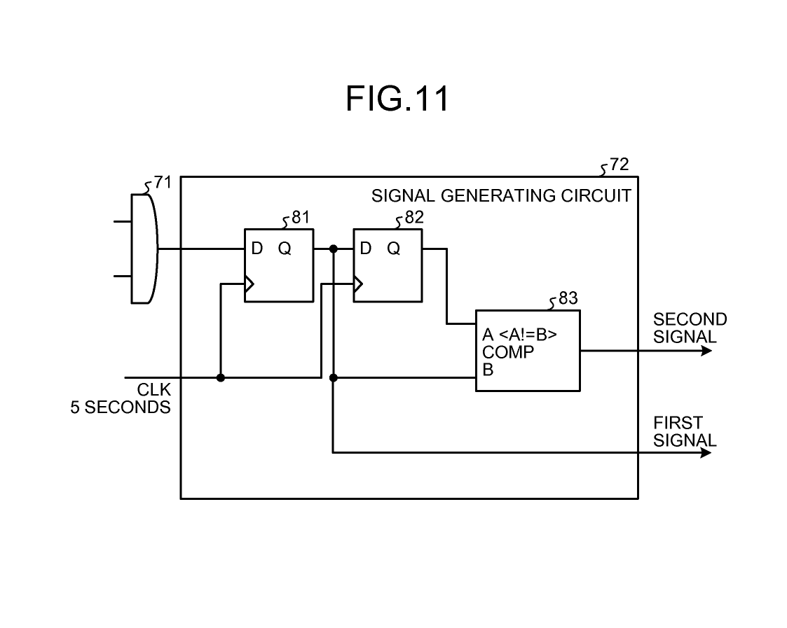

FIG. 11 is a diagram illustrating an example of a configuration of the signal generating circuit. The signal generating circuit 72 includes two D-FF (flip-flop) circuits 81 and 82 and a comparator circuit 83. In the D-FF circuit 81, a D terminal is connected to an output terminal of the AND circuit 71, a clock terminal is connected to the clock signal, and a Q terminal is connected to a D terminal of the D-FF circuit 82 and a B terminal serving as one input terminal of the comparator circuit 83. In the D-FF circuit 82, the D terminal is connected to the Q terminal of the D-FF circuit 81, a clock terminal is connected to the clock signal, and a Q terminal is connected to an A terminal serving as another input terminal of the comparator circuit 83.

The D-FF circuit 81 maintains the state of a signal input to the D terminal at a timing at which a clock signal is input to the clock terminal, and outputs the signal in the maintained state from the Q terminal. When a next clock signal is input to the clock terminal, the D-FF circuit 82 maintains the state of the signal at the Q terminal of the D-FF circuit 81, and outputs the signal in the maintained state from the Q terminal. Therefore, the signal output from the Q terminal of the D-FF circuit 81 is output from the Q terminal of the D-FF circuit 82 by being shifted by one clock period.

In the comparator circuit 83, the A terminal receives a signal that indicates a comparison result of the comparator circuit 83 and that is shifted from a signal at the B terminal by one clock period. The comparator circuit 83 compares an inverted signal of the signal at the A terminal with an inverted signal of the signal at the B terminal. When the signals coincide with each other, the comparator circuit 83 outputs a high-level signal. When the signals do not coincide with each other, the comparator circuit 83 outputs a low-level signal. Namely, the comparator circuit 83 performs comparison with the signal that is a comparison result of the comparator circuit 83 and that is shifted by one clock period, and outputs a high-level signal when the signal has changed. The signal generating circuit 72 outputs, as the second signal, the signal output by the comparator circuit 83 to the CPU 67. The signal generating circuit 72 outputs, as the first signal, the signal output from the Q terminal of the D-FF circuit 81 to the CPU 67.

The first signal at high level indicates that both of the EVDO system and the LTE system are out of range, and the first signal at low level indicates one or both of the EVDO system and the LTE system are in the communication area. The second signal at high level indicates that the state of the first signal has changed, and the second signal at low level indicates that the state of the first signal has not changed.

Referring back to FIG. 3, the CPU 67 controls the entire multi wireless device 8. The CPU 67 functions as various processing units by executing various programs stored in a storage unit, such as the memory 65 or a flash memory (not illustrated). For example, the CPU 67 includes an SMS communicating unit 68 and a notifying unit 69.

The SMS communicating unit 68 transmits and receives an SMS via a point-to-point network. For example, the SMS communicating unit 68 transmits and receives an SMS via the 1x device 50A, the EVDO device 50B, or the LTE device 50C. The SMS communicating unit 68 generally transmits and receives an SMS via a packet communication network of the EVDO network 3 or the LTE network 4 through the EVDO device 50B or the LTE device 50C (SMS over IMS). In addition, when there is no packet communication network that is enabled for communication, the SMS communicating unit 68 transmits and receives an SMS via the 1x network 2 through the 1x device 50A (SMS over 1x).

The notifying unit 69 sends a notice indicating which of the circuit switching system and the packet communication system is used to perform SNS communication, to the VCCAC 10 serving as an SMS switching control server on the network based on the detection results of the detecting unit 54B and the detecting unit 54C. For example, the notifying unit 69 determines whether both of the EVDO system and the LTE system are not enabled to communication based on the first signal at a timing at which the second signal is turned to high level. When it is detected that the first signal is at high level and both of the EVDO system and the LTE system are not enabled for communication, the notifying unit 69 notifies the VCCAC 10 that the SMS communication is to be performed by the 1x system. For example, the notifying unit 69 transmits a Domain Availability Notification (hereinafter, referred to as “SMS (DAN)”) to the VCCAC 10 by using the 1x network 2 to notify the VCCAC 10 that the SMS communication is performed by the 1x system.

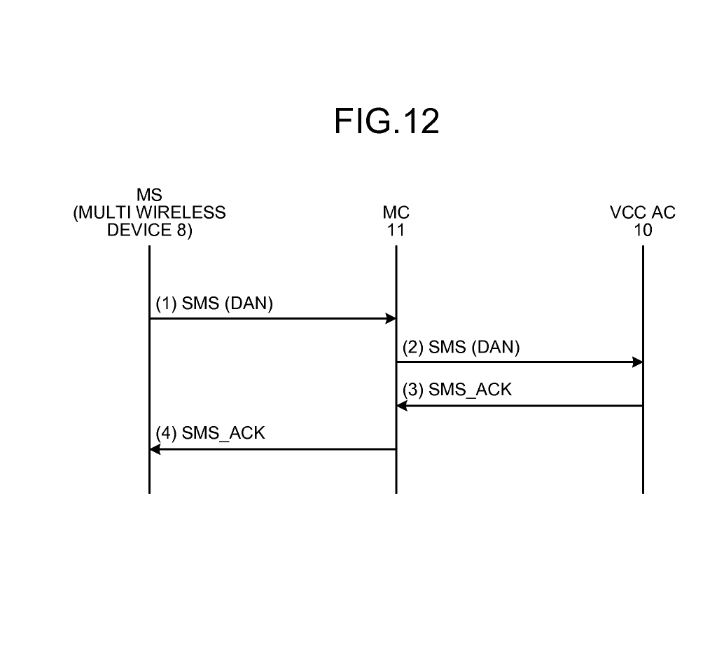

FIG. 12 is a sequence diagram illustrating the flow of operation of the SMS (DAN).
(1) The multi wireless device 8 sends an SMS (DAN) message to the MC 11 by using the 1x network 2.
(2) The MC 11 sends the SMS (DAN) to the VCCAC 10.
(3) When switching of the SMS communication is completed, the VCCAC 10 sends SMS_ACK as a reply to the MC 11.
(4) The MC 11 sends the SMS_ACK as a reply to the multi wireless device 8.

Therefore, because Domain of the SMS communication is switched to the 1x system in the multi wireless system 1, it is possible to prevent the SMS transmission and reception from becoming disabled. In particular, when the multi wireless device 8 transmits and receives an SMS by an OTA (Over the Air Activation) setting command, because the OTA setting command is information on the configuration, the command needs to be received promptly. Therefore, when the packet network goes out of range, the multi wireless device 8 immediately transmits an SMS (DAN) in order to switch the SMS communication to the 1x system, so that the OTA setting command can be received promptly by an SMS.

On the other hand, when it is detected that the first signal is at low level and one or both of the EVDO system and the LTE system are enabled for communication, the notifying unit 69 notifies the VCCAC 10 that the SMS communication is to be performed by the packet communication system of any of the EVDO system and the LTE system. For example, the notifying unit 69 performs IMS Registration by using the EVDO network 3 or the LTE network 4 that is enabled for communication, and send a notice indicating that the SMS communication is performed by the packet communication.

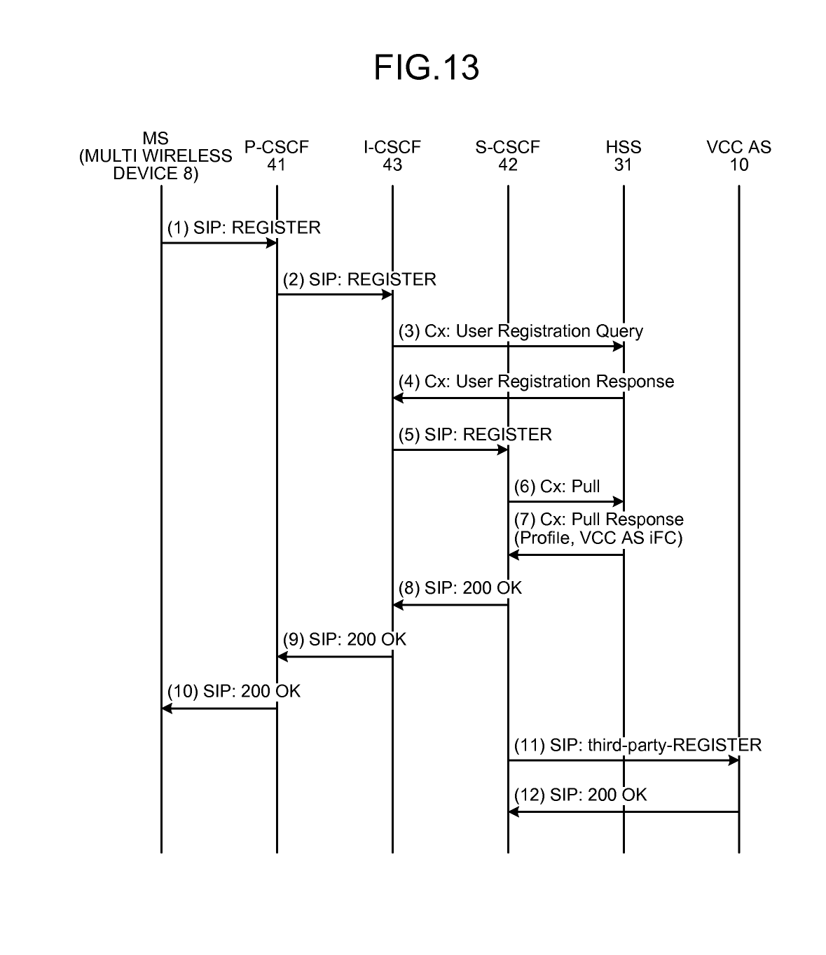

FIG. 13 is a sequence diagram illustrating the flow of operation of the IMS Registration.
(1), (2) The multi wireless device 8 sends an SIP REGISTER message to the I-CSCF 43 via the P-CSCF 41 by using the EVDO network 3 or the LTE network 4 that is enabled for communication.
(3) The I-CSCF 43 sends a Cx User Registration Query message to the HSS 31 in order to acquire an SIP URI (Uniform Resource Identifier) from the S-CSCF 42.
(4) The HSS 31 sends the SIP URI of the S-CSCF 42 and a Cx User Registration Response message back to the I-CSCF 43.
(5) The I-CSCF 43 sends an SIP REGISTER message to the S-CSCF 42.
(6) The S-CSCF 42 sends a Cx Pull message to the HSS 31.
(7) The HSS 31 sends an iFC (Initial Filter Criteria), user/profile information on the VCCAC 10, and the Cx Pull Response message to the S-CSCF 42.
(8) The S-CSCF 42 sends SIP 200 OK to the I-CSCF 43.
(9) The I-CSCF 43 sends SIP 200 OK to the P-CSCF 41.
(10) The P-CSCF 41 sends SIP 200 OK to the multi wireless device 8.
(11) The S-CSCF 42 performs SIP third-party registration on the VCCAC 10 in order to indicate that the multi wireless device 8 has performed registration on the S-CSCF 42, and switches the SMS communication to the 1x system.
(12) When the switching is completed, the VCCAC 10 sends SIP 200 OK to the S-CSCF 42.

Therefore, Domain of the SMS communication is switched to the packet communication and SMS data can be transmitted and received at increased speed. For example, even when the SMS communication is temporarily switched to the 1x system, if communication by the packet network is enabled, IMS Registration is immediately performed so that an SMS can be transmitted and received by packet communication.

Furthermore, when communication by the packet network is switched between enabled and disabled, the notifying unit 69 stores the transmitted SMS switching command in the memory 65. When a next SMS switching command is to be transmitted, and if the same command is stored in the memory 65, the notifying unit 69 cancels the transmission of the command. For example, when SMS (DAN) or IMS Registration is performed, the notifying unit 69 stores the command as a previous command in the memory 65. When the first signal is turned to high level again and SMS (DAN) or IMS Registration is to be performed, and if the previous command stored in the memory 65 is the same as a current command, the notifying unit 69 cancels execution of the command. Therefore, it is possible to prevent the same SMS switching command from being executed multiple times.

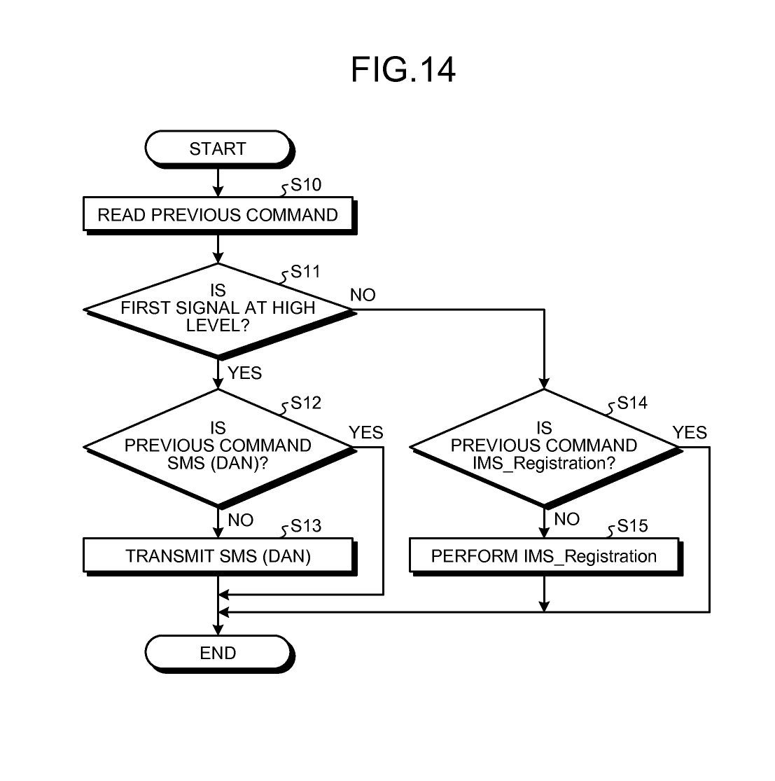

Next, a switching control process performed by the multi wireless device 8 according to the first embodiment to switch between SMS communication paths will be explained below. FIG. 14 is a flowchart illustrating the flow of the switching control process. The switching control process is executed at a timing at which, for example, the second signal is turned to high level.

The notifying unit 69 reads a previous command from the memory 65 (S10). When the previous command is not stored in the memory 65, information, such as NULL, indicating that there is no previous command serves as the previous command.

The notifying unit 69 determines whether the first signal is at high level (S11). When the first signal is at high level (YES at S11), the notifying unit 69 determines whether the previous command is an SMS (DAN) (S12). When the previous command is not an SMS (DAN) (NO at S12), the notifying unit 69 transmits an SMS (DAN) to the VCCAC 10 via the MC 11 by using the 1x network 2 to issue a notice indicating that the SMS communication is to be performed by the 1x system (S13), and the process is terminated. On the other hand, when the previous command is an SMS (DAN) (YES at S12), the process is terminated.

On the other hand, when the first signal is not at high level (NO at S11), the notifying unit 69 determines whether the previous command is IMS Registration (S14). When the previous command is not IMS Registration (NO at S14), the notifying unit 69 performs IMS Registration by using a packet network that is enabled for communication to issue a notice indicating that SMS packet communication is to be performed (S15), and the process is terminated. On the other hand, when the previous command is IMS Registration (YES at S14), the process is terminated.

As described above, the multi wireless device 8 detects whether communication by a packet communication system with faster communication speed than the circuit switching system is enabled. The multi wireless device 8 notifies the VCCAC 10 on the network of which of the circuit switching system and the packet communication system is used to perform SMS communication based on a detection result. As described above, if communication by the packet communication system is not enabled, the multi wireless device 8 sends a notice indicating that the SMS communication is switched to the circuit switching system. Therefore, it is possible to prevent the SMS transmission and reception from becoming disabled.

Furthermore, the multi wireless device 8 detects whether communication by each of the EVDO system and the LTE system of the packet communication system is enabled. When detecting that the communication by both of the EVDO system and the LTE system is not enabled based on a detection result, the multi wireless device 8 notifies the switching control server that the SMS communication is to be performed by the circuit switching system. As described above, even when the multiple packet communication systems such as the EVDO system and the LTE system are provided, if communication by all of the packet communication systems is not enabled, the multi wireless device 8 issues a notice indicating that the SMS communication is to be switched to the circuit switching system. Therefore, it is possible to prevent the SMS transmission and reception from becoming disabled.

Moreover, the multi wireless device 8 includes the signal generating unit 66 that generates the first signal indicating whether both of the EVDO system and the LTE system are out of range based on a detection result, and generates the second signal indicating a timing at which the state of the first signal changes. When the first signal indicates that both of the EVDO system and the LTE system are out of range at a timing indicated by the second signal, the multi wireless device 8 notifies the VCCAC 10 that the SMS communication is to be performed by the circuit switching system. As described above, the multi wireless device 8 performs determination based on the first signal at a timing indicated by the second signal, so that the CPU 67 need not constantly monitor the state of the first signal and the processing load can be reduced.

### [b] Second Embodiment

While the embodiments of the disclosed apparatus have been described above, the disclosed invention may be embodied in various forms other than the above-described embodiments.

For example, while the above embodiment is explained with an example in which the 1x system is used as a communication system of the circuit switching system, the communication system of the circuit switching system is not limited to this example. Furthermore, while the above embodiment is explained with an example in which the EVDO system and the LTE system are used as communication systems of the packet communication system, the communication systems of the packet communication system are not limited to this example. For example, even if a WiMAX (Worldwide Interoperability for Microwave Access) system is employed instead of the LTE system, the same advantageous effects may be obtained. Moreover, while the above embodiment is explained with an example in which two communication systems are employed as the packet communication system, the apparatus of the disclosed technology is not limited to this example. The multi wireless device 8 may include three or more communication systems as the communication systems of the packet communication system. For example, the multi wireless device 8 may further include a wireless LAN.

Furthermore, while a smartphone is described as an example of the multi wireless device 8 in the above embodiment, the same advantageous effect may be obtained even when a tablet terminal or an information terminal equipped with a multi-wireless function is employed.

Moreover, the components illustrated in the drawings do not necessarily have to be physically configured in the manner illustrated in the drawings. In other words, specific forms of distribution and integration of the components are not limited to those illustrated in the drawings, and all or part of the components can be functionally or physically distributed or integrated in arbitrary units according to various loads and the state of use.

Furthermore, all or an arbitrary part of the processing functions implemented by the apparatuses may be realized by a CPU (Central Processing Unit) or a microcomputer, such as an MPU (Micro Processing Unit) or an MCU (Micro Controller Unit). Moreover, all or an arbitrary part of the processing functions may be executed by a program analyzed and executed by the CPU (or a microcomputer, such as an MPU or an MCU), or may be realized by hardware using wired logic.

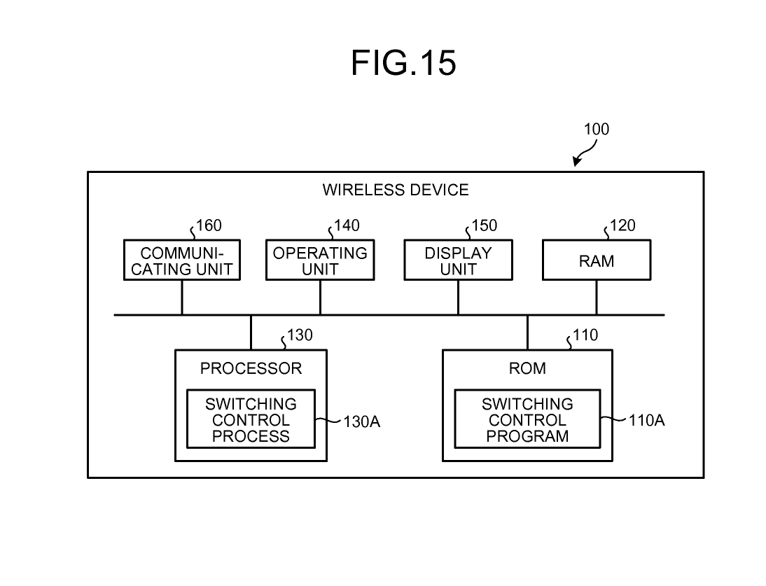

Incidentally, the processes described in the embodiments are realized by causing a wireless device to execute a program prepared in advance. Therefore, an example of a wireless device that executes a program having the same functions as those of the embodiments will be explained below. FIG. 15 is a diagram for explaining a wireless device 100 that executes a switching control program.

In FIG. 15, the wireless device 100 that executes the switching control program includes a ROM 110, a RAM 120, a processor 130, an operating unit 140, a display unit 150, and a communicating unit 160. In the ROM 110, the switching control program that implements the same functions as those of the embodiments is stored in advance. For example, a switching control program that implements the same functions as those of the notifying unit 69 of the embodiments is stored. It may be possible to store the switching control program in a recording medium that can be read by a drive (not illustrated), instead of the ROM 110. As the recording medium, for example, a portable recording medium, such as a CD-ROM, a DVD disk, a USB memory, or an SD card, or a semiconductor memory, such as a flash memory, may be used. The switching control program is, for example, a switching control program 110A as illustrated in FIG. 15. The switching control program 110A may be integrated or distributed appropriately.

The processor 130 reads the switching control program 110A from the ROM 110 and executes the read program. The processor 130 causes the switching control program 110A to function as a switching control process 130A. The switching control process 130A causes the processor 130 to operate in the same manner as each of the processing units of the embodiments. The communicating unit 160 has a multi-wireless communication function for a plurality of communication systems including the LTE system.

The processor 130 of the wireless device 100 acquires a detection result indicating whether communication by the packet communication system is enabled. The processor 130 notifies the VCCAC 10 on the network of which of the circuit switching system and the packet communication system is used to perform SMS communication based on the detection result. As a result, the wireless device 100 can prevent the SMS transmission and reception from becoming disabled.

According to one embodiment of the disclosed technology, it is possible to prevent the SMS transmission and reception from becoming disabled.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A wireless device that is enabled for communication by a first communication system of a circuit switching system and by a second communication system of a packet communication system with faster communication speed than that of the first communication system, the wireless device comprising:
a detecting unit that detects whether communication by the second communication system is enabled; and
a notifying unit that notifies an SMS switching control server on a network of which of the first communication system and the second communication system is used to perform SMS (Short Message Service) communication based on a detection result obtained by the detecting unit.

2. The wireless device according to claim 1, wherein
the detecting unit detects whether communication by a CDMA2000 1xEV-DO (Evolution-Data Only) system and an LTE (Long-Term Evolution) system each serving as the second communication system is enabled, and
when it is detected that the communication by both of the CDMA2000 1xEV-DO system and the LTE system is not enabled based on a detection result obtained by the detecting unit, the notifying unit notifies the switching control server that the SMS communication is performed by the first communication system.

3. The wireless device according to claim 2, further comprising:
a signal generating unit that generates a first signal indicating whether both of the CDMA2000 1xEV-DO system and the LTE system are out of range based on the detection result obtained by the detecting unit, and generates a second signal indicating a timing at which a state of the first signal changes, wherein
the notifying unit notifies the switching control server that the SMS communication is performed by the first communication system when the first signal indicates that both of the CDMA2000 1xEV-DO system and the LTE system are out of range at the timing indicated by the second signal.

4. A computer-readable recording medium having stored therein a switching control program causing a processor of a wireless device that is enabled for communication by a first communication system of a circuit switching system and by a second communication system of a packet communication system with faster communication speed than that of the first communication system, the switching control program causing the processor to perform:
acquiring a detection result obtained by a detecting unit of the wireless device, the detecting unit configured to detect whether communication by the second communication system is enabled, and
notifying an SMS switching control server on a network of which of the first communication system and the second communication system is used to perform SMS (Short Message Service) communication based on the detection result acquired at the acquiring.

5. A switching control method performed by a wireless device that is enabled for communication by a first communication system of a circuit switching system and by a second communication system of a packet communication system with faster communication speed than that of the first communication system, the switching control method comprising:
acquiring a detection result of a detecting unit of the wireless device that detects whether communication by the second communication system is enabled, and
notifying an SMS switching control server on a network of which of the first communication system and the second communication system is used to perform SMS (Short Message Service) communication based on the detection result acquired at the acquiring.
